(19) United States
(12) Patent Application Publication
(10) Pub. No.: US 2016/0259034 A1
(43) Pub. Date: Sep. 8, 2016

(54) POSITION ESTIMATION DEVICE AND POSITION ESTIMATION METHOD

(71) Applicant: Panasonic Intellectual Property Management Co., Ltd., Osaka (JP)

(72) Inventor: TARO IMAGAWA, Osaka (JP)

(21) Appl. No.: 15/046,487

(22) Filed: Feb. 18, 2016

(30) Foreign Application Priority Data
Mar. 4, 2015 (JP) 2015-043010
Oct. 19, 2015 (JP) 2015-205612

(51) Int. Cl. G01S 5/16; B60R 1/00; H04N 5/225; G06K 9/00; H04N 7/18

(52) U.S. Cl. CPC G01S 5/16; G06K 9/00798; G06K 9/00805; H04N 7/183; H04N 5/2256; B60R 1/00; B60R 2300/80

(57) ABSTRACT

The position estimation device that estimates a position of a moving object on a road surface includes an illuminator, an imager, and a controller. The illuminator illuminates the road surface. The imager has an optical axis non-parallel to an optical axis of the illuminator, and images the illuminated road surface. The controller acquires road surface information including a position and a corresponding feature of a road surface to the position. The controller determines a matching region from a road surface image captured by the imager, extracts a feature of the road surface from the road surface image in the matching region, and estimates the position of the moving object by performing matching processing between the extracted feature of the road surface and the road surface information. Furthermore, the controller determines validity of the matching region, and performs the matching processing when determining the matching region is valid.

### BACKGROUND

1. Technical Field

The present disclosure relates to a position estimation device that estimates a position of a moving object on a road surface, and a position estimation method.

2. Description of the Related Art

PTL 1 has disclosed a moving-object position detecting system (a position estimation device) that photographs a dot pattern drawn on a floor surface to associate the photographed dot pattern with position information. This enables a position of a moving object to be detected from an image photographed by the moving object.

### CITATION LIST

### Patent Literature

PTL 1: Unexamined Japanese Patent Publication No. 2010-102585 However, in PTL 1, the position on the floor surface of the moving object is detected with an artificial marker such as the dot pattern and the like being disposed on the floor surface. Therefore, the artificial marker needs to be disposed on the floor surface in advance to detect the position. In order that a precise position of the moving object is estimated, the artificial marker needs to be disposed in minute regional units over a wide range. This poses a problem that the disposition of the artificial marker takes enormous labor.

### SUMMARY

The present disclosure provides a position estimation device that can estimate a precise position of a moving object without an artificial marker or the like.

A position estimation device according to the present disclosure is a position estimation device that estimates a position of a moving object on a road surface, including an illuminator that is provided in the moving object, and illuminates the road surface, and an imager that is provided in the moving object, has an optical axis non-parallel to an optical axis of the illuminator, and images the road surface illuminated by the illuminator. The position estimation device also includes a controller that acquires road surface information including a position and a corresponding feature of a road surface to the position. The controller determines a matching region from a road surface image captured by the imager, extracts a feature of the road surface from the road surface image in the matching region, and estimates the position of the moving object by performing matching processing between the extracted feature of the road surface and the road surface information. The controller further determines validity of the matching region, and performs the matching processing when determining the matching region is valid.

Moreover, a position estimation method according to the present disclosure is a position estimation method for estimating a position of a moving object on a road surface, the position estimation method including: illuminating the road surface, using an illuminator provided in the moving object; and imaging the road surface illuminated by the illuminator, using an imager that is provided in the moving object, and has an optical axis non-parallel to an optical axis of the illuminator. The position estimation method also includes acquiring road surface information including a position and a corresponding feature of a road surface to the position. The position estimation method also includes determining a matching region from a road surface image captured by the imager, extracting a feature of the road surface from the road surface image in the matching region, and estimating the position of the moving object by performing matching processing between the extracted feature of the road surface and the road surface information. Furthermore, the position estimation method includes determining validity of the matching region, and performing the matching processing when determining the matching region is valid.

The position estimation device according to the present disclosure can estimate a precise position of a moving object without an artificial marker or the like.

### BRIEF DESCRIPTION OF DRAWINGS

FIG. 1 is a diagram showing a configuration of a moving vehicle including a position estimation device according to a first exemplary embodiment;

FIG. 2 is a flowchart for describing one example of position estimation operation of the position estimation device according to the first exemplary embodiment;

FIG. 3 is a flowchart showing one example of feature extraction processing performed by the position estimation device according to the first exemplary embodiment;

FIG. 4 is a diagram showing examples of a shape of an illumination region illuminated by an illuminator according to the first exemplary embodiment;

FIG. 5 is a diagram showing an array formed by a gray-scale feature that is obtained by binarization of a captured image, according to the first exemplary embodiment;

FIG. 6 is a diagram showing one example of road surface information according to the first exemplary embodiment;

FIG. 7 is a flowchart showing one example of acquisition processing of the road surface information according to the first exemplary embodiment;

FIG. 8A is a diagram showing an example of an illumination pattern produced by an illuminator according to another exemplary embodiment;

FIG. 8B is a diagram showing an example of an illumination pattern produced by an illuminator according to another exemplary embodiment;

FIG. 9 is a diagram for explaining one method of detecting a concavo-convex shape of a road surface, according to another exemplary embodiment; and

FIG. 10 is a diagram for explaining another method of detecting the concavo-convex shape of the road surface, according to another exemplary embodiment.

### DETAILED DESCRIPTION

Hereinafter, with reference to the drawings as needed, exemplary embodiments will be described in detail. However, more detailed description than necessary may be omitted. For example, detailed description of a well-known item and overlapping description of substantially the same configuration may be omitted. This is to avoid unnecessary redundancy of the following description, and to facilitate understanding of those in the art.

The accompanying drawings and the following description are provided for those in the art to sufficiently understand the present disclosure, and are not intended to limit the subject described in the claims.

### First Exemplary Embodiment

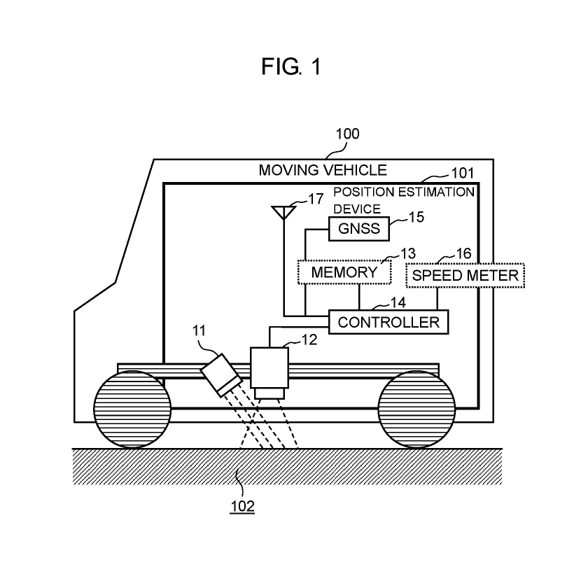

Hereinafter, with reference to FIGS. 1 to 7, a first exemplary embodiment will be described.

### 1-1. Configuration

First, a configuration of a position estimation device according to the present exemplary embodiment will be described with reference to FIG. 1.

FIG. 1 is a diagram showing a configuration of moving vehicle 100 (an example of a moving object) including position estimation device 101 according the first exemplary embodiment.

Position estimation device 101 is a device that estimates a position and an orientation of moving vehicle 100 on road surface 102. Position estimation device 101 includes illuminator 11, imager 12, memory 13, controller 14, Global Navigation Satellite System (GNSS) 15, speed meter 16, and communicator 17.

Illuminator 11 is provided in moving vehicle 100 to illuminate a part of road surface 102. Moreover, illuminator 11 emits a parallel light. Illuminator 11 is configured, for example, by a light source such as an LED (Light Emitting Diode), an optical system that forms a parallel light, or the like.

The parallel light means illumination of a parallel light flux. The parallel light from illuminator 11 causes the illuminated region to be uniform in size regardless of a distance (a distance from illuminator 11 to road surface 102). Illuminator 11 may use, for example, a telecentric optical system to perform the illumination with parallel light emitted by the telecentric optical system. Alternatively, the parallel light may be radiated by a plurality of spot beams, which have rectilinearity and are disposed parallel to one another, to perform the illumination. When the parallel light is used, the size of the region can be made constant regardless of the distance from illuminator 11 to road surface 102, and a region required for the position estimation can be accurately set to perform correct matching.

Imager 12 is provided in moving vehicle 100. Imager 12 has an optical axis non-parallel to an optical axis of illuminator 11, and images road surface 102 illuminated by illuminator 11. Specifically, imager 12 images road surface 102 including an illumination region (see below) illuminated by illuminator 11. Imager 12 is configured, for example, by a camera.

Illuminator 11 and imager 12 are fixed to, for example, a bottom portion of a body of moving vehicle 100. The optical axis of imager 12 is preferably perpendicular to the road surface. Thus, if it is assumed that moving vehicle 100 is disposed on a planer road surface, imager 12 is fixed so that the optical axis of imager 12 is perpendicular to the road surface. Moreover, since illuminator 11 has the optical axis non-parallel to the optical axis of imager 12, the above-described planar road surface is irradiated obliquely with the parallel light, by which a partial region (hereinafter, referred to as an “illumination region”) of a region of the road surface that imager 12 images (hereinafter, referred to as an “imaging region”) is illuminated.

Controller 14 acquires road surface information stored in memory 13 described later. The road surface information includes a feature of road surface 102 associated with a position and an orientation. Controller 14 estimates the position of moving vehicle 100 by matching processing of extracting the feature of road surface 102 from a captured road surface image, and matching the extracted feature of road surface 102 with the acquired road surface information. Controller 14 may estimate, by the matching processing, the orientation of the moving vehicle, which is a direction to which moving vehicle 100 is oriented. Controller 14 finds, for example, a two-dimensional gray-scale pattern of road surface 102 from the region illuminated by illuminator 11 in the road surface image, and performs the matching processing, based on the two-dimensional gray-scale pattern. Moreover, controller 14 may perform the matching processing, for example, by matching a binarized image with the road surface information, in which the binarized image is obtained by binarizing the gray-scale image of road surface 102. Here, the position of moving vehicle 100 is a position on road surface 102 where moving vehicle 100 moves, and the orientation is a direction to which a front surface of moving vehicle 100 is oriented on road surface 102. Controller 14 is configured, for example, by a processor, a memory in which a program is stored, or the like.

Memory 13 stores the road surface information indicating a relation between the feature of road surface 102 and the position. The road surface information may not be stored in memory 13 but may be acquired from an external device through communication in the matching processing. Memory 13 is configured, for example, by a non-volatile memory or the like.

The position included in the road surface information is information indicating an absolute position. Moreover, the road surface information may be information including the absolute portion associated with a direction at the absolute position. In the present exemplary embodiment, the road surface information includes the position and the direction associated with the feature of road surface 102.

The feature of road surface 102 included in the road surface information indicates the two-dimensional gray-scale pattern of road surface 102. Specifically, the road surface information includes a binarized image as the feature of the road surface. The binarized image is obtained by binarizing the gray-scale image of road surface 102. Road surface 102 as a source of the road surface information is preferably a surface of a road constructed by a material having a non-uniform surface in its feature such as reflectance, concavo-convex, color and the like. The material may be, for example, asphalt, concrete, wood and the like.

GNSS 15 determines a rough position of the moving vehicle. That is, GNSS 15 is a position estimator that performs position estimation with a precision lower than that for the position of the moving vehicle that the controller 14 estimates. GNSS 15 is configured, for example, by a GPS (Global Positioning System) module that estimates the position by receiving a signal from a GPS satellite, or the like.

Speed meter 16 measures a movement speed of moving vehicle 100. Speed meter 16 is configured, for example, by a speed meter that measures a speed of moving vehicle 100 from a rotation signal obtained from a driven gear of moving vehicle 100.

Communicator 17 acquires the road surface information to be stored in memory 13 from an external device through communication as needed. In other words, the road surface information stored in memory 13 need not be all of the road surface information, but may be a part of the road surface information. That is, the road surface information may include the features of the road surfaces associated with the positions all over the world, or may only include the features of the road surfaces associated with the positions within a predetermined country. Alternatively, the road surface information may only include the features of the road surfaces associated with the positions within a predetermined district, or may only include the features of the road surfaces and the positions within a predetermined facility such as a factory. As described above, the road surface information may include the orientation and the position associated with the feature of the road surface. Communicator 17 is configured, for example, by a communication module capable of performing communication by a portable telephone communication network or the like.

### 1-2. Operation

Operation of position estimation device 101 configured as described above will be described.

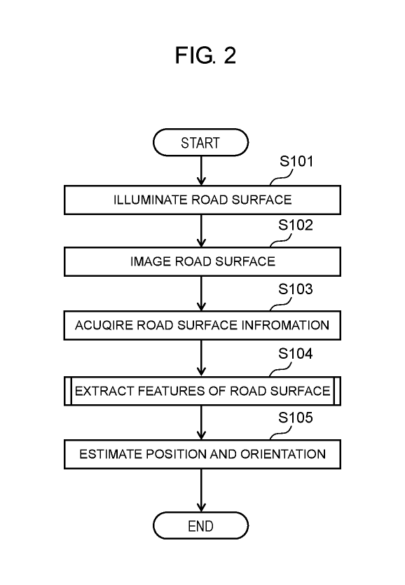

FIG. 2 is a flowchart for describing one example of position estimation operation of position estimation device 101 according to the first exemplary embodiment.

First, illuminator 11 illuminates the road surface (S101). Specifically, illuminator 11 emits the parallel light from an oblique direction with respect to the illumination region within the imaging region to be imaged by imager 12, and thereby illuminates the road surface.

Next, imager 12 images the road surface (S102). Specifically, imager 12 images the road surface including all the region of the illumination region illuminated by illuminator 11. That is, all the region of the illumination region is included in the imaging region.

Next, controller 14 acquires the road surface information stored in memory 13. The acquired road surface information includes the position or the direction associated with the feature of road surface 102 (S103).

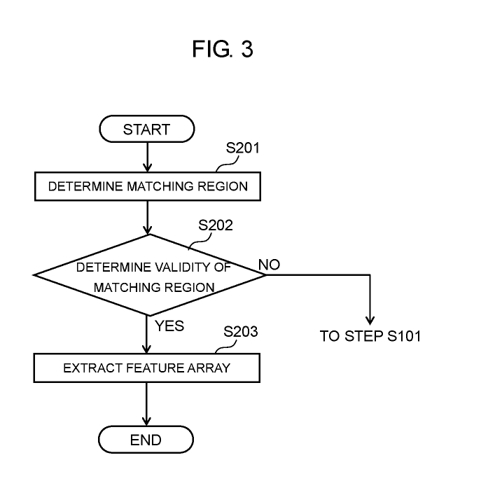

Next, controller 14 extracts the feature from the road surface image captured by imager 12 (S104). Details of processing for extracting the feature in step S104 (hereinafter, referred to as “feature extraction processing”) will be described below with reference to FIG. 3.

The feature extraction processing for extracting the feature from the road surface image (S104) will be described with reference to FIG. 3.

FIG. 3 is a flowchart showing one example of the feature extraction processing of position estimation device 101 according to the first exemplary embodiment.

In the feature extraction processing, first, controller 14 determines a matching region as an object to which the feature extraction processing is performed from the captured image, based on a shape of the illumination region (hereinafter, referred to as an “illumination shape”) of the parallel light radiated to road surface 102 by illuminator 11 (S201).

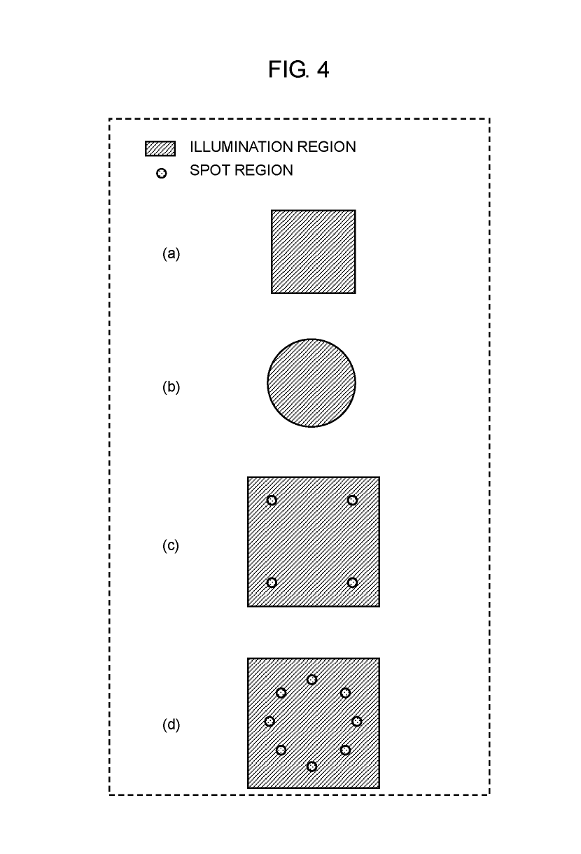

Specific examples of the illumination shape are shown in FIG. 4.

FIG. 4 is a diagram showing examples of the shape (illumination shape) of the illumination region illuminated by illuminator 11 according to the first exemplary embodiment. The illumination shapes shown in (a) to (d) of FIG. 4 are shapes of the illumination region seen from the information of the road surface. The illumination shape of the illuminator 11 as shown in (a) to (d) of FIG. 4 may be different for each position estimation device 101, or may be changeable in one position estimation device. For example, the illumination shape may be changed in accordance with a condition of the road surface or the like. Moreover, in FIG. 4, regions of slant lines in (a) to (d) each indicate the illumination region, and regions of dot portions in (c) and (d) each indicate a spot region which is irradiated with a spot beam.

(a) of FIG. 4 is a diagram showing an example in which the illumination shape is quadrangular. In this case, this shape has a compatibility with a shape of a general image sensor, which enables detection values of a plurality of pixels in the image sensor to be employed without waste. In the case where the illumination shape is quadrangular, the matching region may correspond to the whole quadrangle of the illumination shape, or may be an inner region of the illumination shape positioned with reference to a rectangular position of the illumination shape. If the matching shape is the inner region positioned with reference to a rectangular position of the illumination shape, it may be set to, for example, a region having the same center as that of the illumination shape, and having an area 10% smaller than that of the illumination shape.

(b) of FIG. 4 is a diagram showing an example in which the illumination shape is circular. In this case, the matching shape can be unchanged in the matching in which the orientation is varied.

(c) of FIG. 4 is a diagram showing an example including a larger illumination region with a plurality of spot regions (regions which are irradiated with spot beams) designating a rectangular matching region. In this case, the matching region is a rectangular region defined by connecting the plurality of spot regions. In this case, as in the example of (a) of FIG. 4, the matching shape may be set to, for example, a region having the same center as that of the rectangular region defined by connecting the plurality of spot regions, and having an area 10% smaller than that of the rectangular region.

(d) of FIG. 4 is a diagram showing an example including an illumination region similar to that in (c) of FIG. 4, combined with a plurality of spot regions designating a circular matching region. In this case, the matching region is a circular region defined by connecting the plurality of spot regions. With the circular disposition of the plurality of spot regions, a similar effect to that in (b) of FIG. 4 can be obtained.

The matching regions shown in (c) and (d) of FIG. 4 may be determined for each position estimation device 101, or may be changeable in one position estimation device. For example, the size and the shape of the matching region may be changed in accordance with the condition of the road surface or the like.

The spot regions in (c) and (d) of FIG. 4 may be each a region which is irradiated with a red-colored spot beam or the like, or may be each a region which is irradiated with a spot beam having a luminance different from that of the light in the illumination region. Moreover, the light radiated to the spot regions may have a wavelength different from the light radiated in the illumination region. That is, the spot regions are regions which are irradiated with spot beams, which enable the spot regions to be distinguished from the illumination region.

In step S201, the matching region is determined from the road surface image in which an illumination region, such as that shown in (a) to (d) of FIG. 4, is imaged, as described above.

Next, controller 14 determines validity of the matching region determined in step S201 in view of influence by deformation of the shape of the illumination region, and the like (S202). If moving vehicle 100 is inclined with respect to road surface 102, the shape of the illumination region (the illumination shape) illuminated by illuminator 11 may be deformed. Thus, step S202 is performed so that the influence by the above-described deformation and the like is considered. If the validity of the matching region can be secured in advance, step S202 may be omitted. The inclination of moving vehicle 100 with respect to road surface 102 can be determined, based on deviation of the illumination shape from the prescribed shape. For example, the inclination can be determined, based on change in an aspect ratio of the quadrangular shape of the illumination region in (a) of FIG. 4, change of the circular shape in (b) of FIG. 4 to an ellipse, or the like. Using a rotational symmetric pattern such as the circle (or a shape close to a circle) in (b) or (d) of FIG. 4 can facilitate the determination for detecting the inclination in an arbitrary direction.

If the matching region is determined to be valid (Yes in S202), controller 14 extracts a feature array (S203). That is, even if the above-described deformation occurs in the illumination region of the captured road surface image with a less degree of deformation than a predetermined degree, controller 14 continues the feature extraction processing. In the case of the predetermined degree of deformation, controller 14 may correct the shape of the matching region and then shift the processing to the feature extraction processing. For example, in the case of the illumination including the circular shape as in (b) or (d) of FIG. 4, with a shorter axis of an ellipse as a reference, a circular shape having the same center as that of the ellipse and having a radius equivalent to the shorter axis can be set as the matching region.

Even if road surface 102 is imaged at the same position, a change in size (scale) of the matching region makes the extracted feature array completely different. Variation in distance between illuminator 11 and road surface 102 may cause the matching region to be changed in size as described above. In the present disclosure, the illumination light is used to set the size of the matching region, by which the above-described change is detected. If the size is changed, the matching region can be corrected to a proper size.

On the other hand, if controller 14 determines that the matching region is invalid (No in S202), the processing returns to step S101. That is, if the above-described deformation occurs in the illumination region of the captured road surface image, and the deformation exceeds a predetermined degree of deformation, controller 14 ends the feature extraction processing in the captured image to shift the processing to the position estimation operation with a new captured image (i.e., returns to step S101).

In the extraction of the feature array, controller 14 extracts the feature array indicating a gray scale of road surface 102 from the matching region of the captured road surface image. Here, the gray scale is not an array of gray scale equivalent to a size of moving vehicle 100, but an array of so micro gray scale that does not affect the traveling and the like of moving vehicle 100 is used. Imaging a feature array on the above-described scale is enabled by using a camera with high resolution enough to capture such microscale images. When the extracted feature array is of a gray scale, controller 14 may extract, as the feature array, values obtained by binarizing an average luminance for each predetermined region from the matching region of the road surface image, or may extract, as the feature array, values obtained by multi-leveling the average luminance. The feature array may be an array of concavo-convex or color (wavelength spectral feature) may be employed in place of the gray scale array.

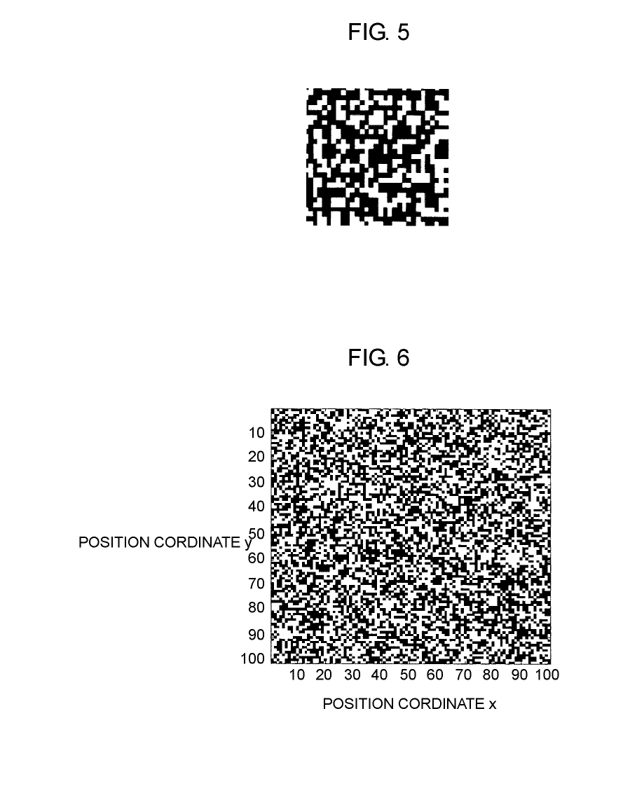

FIG. 5 is a diagram showing the feature array including a gray-scale feature obtained when the captured image is binarized, according to the first exemplary embodiment. Specifically, FIG. 5 is a diagram showing an example of the feature array including a gray scale obtained by dividing the matching region into a plurality of blocks each made of a plurality of pixels, calculating an average value of pixel values for each of the plurality of blocks, and binarizing the captured image, based on whether or not the average value in each block exceeds a predetermined threshold.

Upon extracting the feature array as shown in FIG. 5 as the feature of the road surface, controller 14 ends the feature extraction processing in step S104, and advances the processing to next step S105.

With reference back to FIG. 2, controller 14 estimates the position or the direction of moving vehicle 100 through the processing of matching the acquired road surface information with the extracted feature of the road surface (S105). Here, the road surface information is information in which the position information indicating a position is associated with the feature array as a feature of the road surface. In step S105, specifically, controller 14 evaluates similarity between the feature array extracted in step S203, and the feature array associated with the position information in the road surface information to thereby perform the matching processing.

FIG. 6 is a diagram showing one example of the road surface information according to the first exemplary embodiment. A horizontal axis and a vertical axis in FIG. 6 indicate a position in an x-axis direction and a position in a y-axis direction, respectively. That is, in the road surface information shown in FIG. 6, the gray-scale feature array of the road surface is associated with position coordinates x, y. A minimum unit for the monochrome pattern is represented by one block of the feature array in a range of 0 to 100 of position coordinates x, y in the x-axis direction and y-axis direction. In this case, controller 14 performs the matching processing with the feature array in FIG. 5 for each of the position and the orientation to thereby calculate the similarity of the extracted feature array to that in the road surface information. The calculation of the similarity can be performed by applying an index used for general pattern matching, such as expressing the feature arrays by vector and evaluating their difference. Controller 14 estimates the position and the orientation as a result of the matching processing. As the position and the orientation of moving vehicle 100, controller 14 employs the position and the orientation having a matching degree (the similarity) that exceeds a predetermined reference and is highest. If the matching degree does not exceed the predetermined reference, or if a plurality of positions have similar matching degrees, it is determined that reliability of the matching processing result is low. If it is determined that the reliability of the matching processing result is low, the position estimation may be performed again, or a determined value for the position and the orientation including its reliability degree (e.g., information indicating the position coordinates together with information indicating that the reliability degree is low) may be output.

Moreover, for the matching processing, robust matching (M—estimation, least median squares, or the like) may be desirably used. In the case where the position and the orientation of moving vehicle 100 are determined using the feature of road surface 102, presence of foreign substances, damage or the like on road surface 102 may cause a failure in exact matching. The larger the size of the feature array used for the matching processing is, the larger an information amount included in the feature array is, which will enable accurate matching to be performed. However, a processing cost required for matching increases. Thus, in place of using the feature array of a larger size than necessary, the robust matching, in which accurate matching can be performed even with the feature array being partially masked by an obstacle or the like, is effective for the position estimation using the road surface 102.

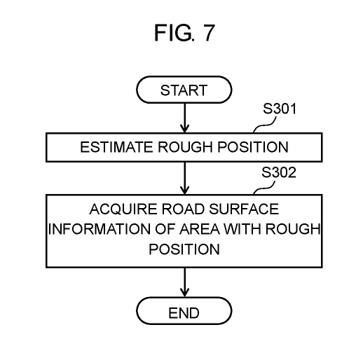

In the case where the road surface information including position information for a wide area is an object of the matching processing, the matching processing throughput is enormous. Thus, for increase the speed of the matching processing, hierarchical matching processing, in which detailed matching is performed after rough matching, may be performed. For example, controller 14 may narrow and acquire the road surface information, based on a result from the position estimation with a low precision by GNSS 15. Acquisition processing of the road surface information in step S103 in this case will be described with reference to FIG. 7.

FIG. 7 is a flowchart showing one example of the acquisition processing of the road surface information according to the first exemplary embodiment.

In the acquisition processing of the road surface information, first, GNSS 15 performs the rough position estimation (S301). In this manner, the position information to be matched is narrowed down in advance, which can reduce time and a processing throughput (processing load) required for the matching processing. The rough position estimation is not limited to using the position information acquired by GNSS 15, but may use a position in the vicinity of the position information acquired in past as a position with a low precision. Moreover, the rough position estimation may use position information of a base station of a public wireless network, a wireless LAN and the like, or a result of the position estimation using a signal intensity of wireless communication.

Next, controller 14 acquires the road surface information of an area including the position with the low precision (S302). Specifically, using a result from the rough position estimation, controller 14 acquires the road surface information including the position information in the vicinity of the position with the low precision from an external database through communicator 17.

In this manner, after the position estimation with the low precision is performed, the road surface information of the area including the position is acquired, which can reduce an amount of memory required for memory 13. Moreover, a data size of the road surface information subjected to the matching processing can be made smaller. Accordingly, the processing load involved with the matching processing can be reduced.

Controller 14 may perform the matching processing in accordance with a moving speed of moving vehicle 100 measured by speed meter 16. For example, controller 14 may perform the matching processing only if the measured moving speed does not reach a predetermined speed. As the measured moving speed is higher, controller 14 may perform the imaging with a higher shutter speed of imager 12. Controller 14 may perform the imaging with a higher shutter speed of the imager 12 if the measured moving speed is higher than a predetermined speed. Controller 14 may perform the image processing for sharpening the captured image if the measured moving speed is higher than a predetermined speed. This is because the high speed of moving vehicle 100 may easily cause a matching error due to movement blur. In this manner, using the speed of moving vehicle 100 allows imprecise matching to be avoided.

### 1-3. Effects, Etc.

As described above, in the present exemplary embodiment, position estimation device 101 is a position estimation device that estimates the position or the orientation of moving vehicle 100 on the road surface, and includes illuminator 11, imager 12, and controller 14. Illuminator 11 is provided in moving vehicle 100 and irradiates road surface 102. Imager 12 is provided in moving vehicle 100, includes the optical axis non-parallel to the optical axis of illuminator 11, and images road surface 102 illuminated by illuminator 11. Controller 14 acquires the road surface information in which the position or the direction is associated with the feature of the road surface. Moreover, controller 14 estimates the position and the orientation of moving vehicle 100 by the matching processing, the matching processing including determining the matching region from the captured road surface image, determining the validity of the matching region, extracting the feature of road surface 102 from the road surface image of the matching region determined to be valid, and matching the extracted feature of road surface 102 with the acquired road surface information.

According to this, the matching processing is performed using the feature of road surface 102, which originally includes a random feature in a minute region, with the road surface information in which the feature is associated with the position or the direction, thereby estimating the position or the orientation (the direction to which moving vehicle 100 is oriented). Accordingly, the precise position (e.g., the position with a precision of millimeter units) of moving vehicle 100 can be estimated without any artificial marker or the like being arranged. Moreover, since road surface 102 is imaged to estimate the position, a visual field of imager 12 is prevented from being shielded by an obstacle, a structure or the like around the moving vehicle, so that the position estimation can be done continuously in a stable manner.

Moreover, since controller 14 performs the matching processing for only the matching region determined to be valid, a situation can be prevented where the matching processing cannot be accurately executed due to deformation, inclination or the like of the road surface, so that more accurate position estimation can be performed.

Moreover, the road surface information includes information in which the information indicating the absolute position as the position is associated with the feature of road surface 102 in advance. Thereby, the absolute position on the road surface where moving vehicle 100 is located can be easily estimated.

Moreover, illuminator 11 performs illumination, using the parallel light. According to this, since illuminator 11 radiates the parallel light to thereby illuminate road surface 102, change in the size of the illuminated region of road surface 102 can be reduced even if the distance between illuminator 11 and the road surface changes. With the matching region being determined from the region of road surface 102 illuminated by illuminator 11 (the illumination region) in the road surface image captured by imager 12, the size of the road surface 102 can be more accurately estimated. Thus, the position of moving vehicle 100 can be more accurately estimated.

Moreover, the road surface information includes information indicating the two-dimensional gray-scale pattern of road surface 102 as the feature of road surface 102 being associated with the position. Controller 14 identifies the two-dimensional gray-scale pattern of road surface 102 from the region illuminated by illuminator 11 in the road surface image and perform the matching processing, based on the identified two-dimensional gray-scale pattern.

According to this, since the feature of road surface 102 is indicated by the two-dimensional gray-scale pattern of the road surface 102, the image differs, depending on the orientation of the captured image even at the same position. Therefore, the position of the moving vehicle is estimated, and at the same time, the orientation of the moving vehicle (the direction to which the moving vehicle is oriented) can be easily estimated.

Moreover, the road surface information includes information in which the binarized image is associated with the position as the feature of road surface 102, the binarized image being obtained by capturing the gray-scale pattern of road surface 102 and binarizing the captured road surface image. For the matching processing, controller 14 performs the processing of matching between the binarized image and the road surface information.

Thus, the feature of road surface 102 can be simplified by the gray scale pattern. This can make the data size of the road surface information smaller, so that the processing load involved with the matching processing can be reduced. Moreover, since the data size of the road surface information stored in memory 13 can be made smaller, a storage capacity of memory 13 can be made smaller.

Moreover, position estimation device 101 may further include a position estimator, which may include GNSS 15 and performs the position estimation with a precision lower than that of the position of moving vehicle 100 estimated by controller 14. Controller 14 may narrow and acquire the road surface information, based on the result of the position estimation by the position estimator. This can reduce a memory capacity required for memory 13. Moreover, the data size of the road surface information subjected to the matching processing can be made smaller. Accordingly, the processing load involved with the matching processing can be reduced.

Moreover, controller 14 may perform the matching processing in accordance with the moving speed of moving vehicle 100. This allows imprecise matching to be avoided.

### Other Exemplary Embodiments

As described above, as exemplification of the technique disclosed in the present application, the first exemplary embodiment has been described. However, the technique according to the present disclosure is not limited thereto, but can be applied to exemplary embodiments resulting from modifications, replacements, additions, omissions and the like. Moreover, the respective components described in the above-described exemplary embodiment can be combined to obtain new exemplary embodiments.

Consequently, in the following description, other exemplary embodiments will be exemplified.

For example, while in the above-described exemplary embodiment, the gray-scale pattern of road surface 102 is extracted as the feature of road surface 102, the present disclosure is not limited thereto, but a concavo-convex shape of road surface 102 may be extracted. Since inclination of illuminator 11 with respect to the optical axis of imager 12 produces shades corresponding to the concavo-convex shape of road surface 102, an image in which the produced shades are subjected to multivalued expression may be employed as the feature of road surface 102. In this case, the feature of road surface 102 can be represented by, for example, light convex portions and dark concave portions, and therefore, a binarized image as shown in FIG. 5 may be obtained by binarization of the luminance obtained from a concavo-convex shape, instead of a gray scale pattern.

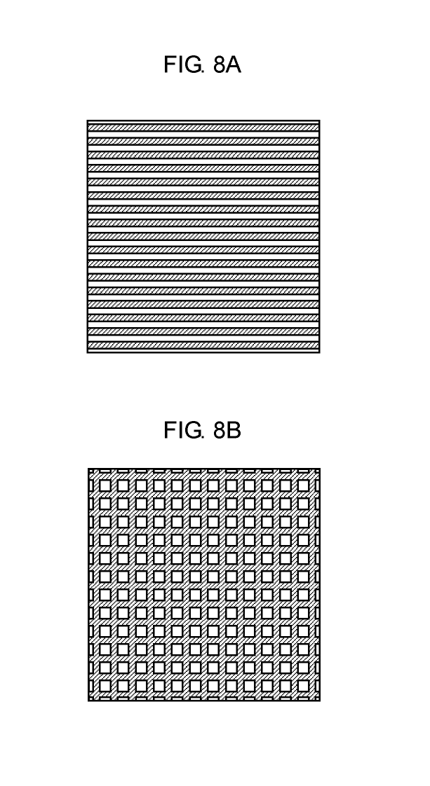

In this manner, when the concavo-convex shape of road surface 102 is identified, illuminator 11 may irradiate the illumination region with pattern light, or light forming a predetermined pattern, instead of uniform light. The pattern light may be in the form of a striped pattern (see FIG. 8A), a dot array, a lattice pattern (see FIG. 8B) or the like. In short, illuminator 11 only needs to radiate light in the form of a certain pattern. Illuminator 11 radiates such pattern light, by which a concavo-convex feature of road surface 102 as will be described later can be detected easily.

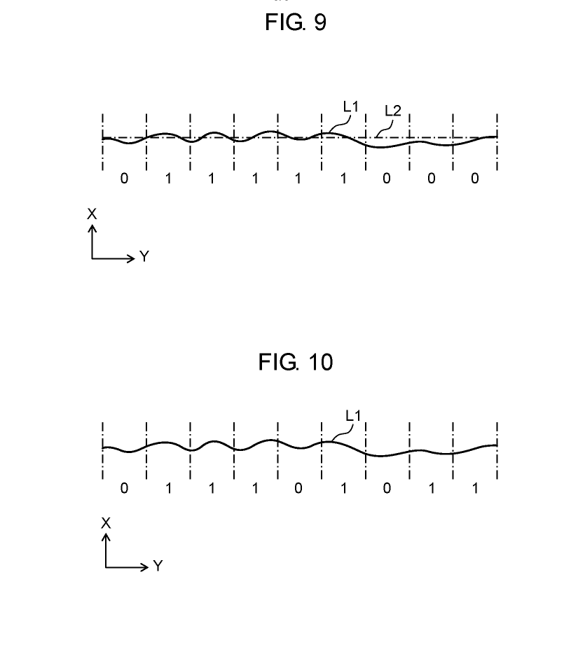

FIG. 9 is a diagram for describing one example of a method for identifying the concavo-convex shape of the road surface according to the other exemplary embodiment. FIG. 10 is a diagram for describing another example of the method for identifying the concavo-convex shape of the road surface according to the other exemplary embodiment. Specifically, FIGS. 9 and 10 are diagrams for describing the method for extracting the feature of the concavo-convex shape of the road surface using striped pattern light.

When the striped pattern light as shown in FIG. 8A is radiated to the road surface from an oblique direction, an edge portion between light and dark portions of the striped pattern light can be extracted as wavy line L1, as shown in FIGS. 9 and 10. FIGS. 9 and 10 show an example in which one of a plurality of edge portions between light and dark portions of the striped pattern light is extracted.

FIG. 9 shows an example in which projection or depression is determined, depending on to which side in an X-direction wavy line L1 deviates from straight line L2, which indicates an edge portion between the light and dark portions of the striped pattern light radiated onto a smooth road surface. As shown in FIG. 9, wavy line L1 is divided into a plurality of regions in a Y-axis direction (e.g., the above-described regions of block units). In this case, for each of the plurality of regions, if the region includes more pixels in which wavy line L1 exists on a plus side than a minus side in the X-axis direction with respect to straight line L2, “1” indicating projection may be set, and if the region includes more pixels in which wavy line L1 exists on the minus side than the plus side, “0” indicating depression may be set.

Moreover, as shown in FIG. 10, wavy line L1 may be divided into a plurality of regions in the Y-axis direction (e.g., the regions of the above-described block units). In this case, for each of the plurality of regions, if a number of pixels in which wavy line L1 is projected upward is larger than a number of pixels in which wavy line L1 is projected downward, “1” indicating projection may be set, and if the number of pixels in which wavy line L1 is projected downward is larger than the number of pixels in which wavy line L1 is projected upward, “0” indicating depression may be set.

The above-described processing is performed for each of the plurality of edge portions between light and dark portions of the striped pattern light, by which the values of the projection or the depression in the X-axis direction can be calculated, and the two-dimensional pattern of the concavo-convex feature can be obtained.

The edge portion between light and dark portions in this case may be an edge between a light portion above and a dark portion below of the striped pattern light, or may be an edge between a dark portion above and a light portion below.

Moreover, a stereo camera or a laser range finder may be used for detection of the concavo-convex shape.

In the case where the above-described feature of a concavo-convex shape is employed as the feature of road surface 102, a concavo-convex degree of road surface 102 may be numerically expressed.

The use of the concavo-convex feature enables the feature detection to be hardly affected by local change in luminance distribution in the road surface due to rain or dirt.

Beside the gray scale feature and the concavo-convex feature, a feature of color may be set as the feature of the road surface, and the feature of the road surface may be obtained from an image captured, using invisible light (infrared light or the like). The use of color increases an information amount, which can enhance determination performance. Moreover, the use of invisible light can make the light radiated from the illuminator inconspicuous to human eyes.

Moreover, for the feature of road surface 102, an array of a SIFT (Scale Invariant Feature Transform), FAST (Features from Accelerated Segment Test), SURF (Speed-Up Robust Features) feature amount or the like may be used.

Furthermore, for the feature amount, a spatial change amount (a differential value) may be used in place of the value itself of the gray scale, the roughness, color or the like as described above. Discrete differential value expression may be used. For example, in a horizontal direction, if the differential value increases, 1 is set, if the differential value does not change, 0 is set, and if the differential value decreases, −1 is set. This allows the feature amount to be less affected by environment light.

In the above-described exemplary embodiment, the moving vehicle moving on road surface 102 images the road surface and thereby, the position is estimated. Instead, for example, a wall surface may be imaged while the moving vehicle is moving along the wall surface of a building, a tunnel, a dam or the like, and a result from imaging the wall surface may be used to estimate a position of the moving vehicle. In this example, the road surface includes a wall surface.

In the above-described exemplary embodiment, a configuration other than illuminator 11, imager 12, and communicator 17 of position estimation device 101 may be on a cloud network. The road surface image captured by imager 12 may be transmitted to the cloud network through communicator 17 to perform the processing of the position estimation on the cloud network.

In the above-described exemplary embodiment, a polarizing filter may be attached to at least one of illuminator 11 and imager 12 to thereby reduce a specular reflection component of road surface 102. This can increase contrast of the gray-scale feature of road surface 102 and reduce an error in the position estimation.

In the above-described exemplary embodiment, the position estimation is performed with low precision and then with higher precision. This allows the road surface information to be acquired from the area which is narrowed down by the rough position estimation. The acquired road surface information is then used to perform the matching processing, which increases the speed of the matching processing. However, this is not the only option in the present disclosure. For example, an index or a hash table may be created in advance so as to enable the high-speed matching.

Moreover, while in the above-described exemplary embodiment, controller 14 determines the matching region from the captured road surface image (S201 in FIG. 3), and determines the validity from the shape of the matching region (S202 in the same figure), the present disclosure is not limited thereto. In place of this, controller 14 may determine the validity of the matching region, based on the feature of the road surface 102 extracted from the road surface image of the matching region (e.g., the feature array obtained in S203 in FIG. 3). Controller 14 can determine the validity based on, for example, a situation that the feature amount of the concave and convex shape does not reach a predetermined least amount that should be obtained, or a situation that sufficient matching cannot been found in matching with a map. Since controller 14 performs the matching processing only to the matching region determined to be valid, the matching processing can be prevented from being inaccurate due to deformation, inclination or the like of the road surface, so that more accurate position estimation can be performed.

The present disclosure can also be realized as a position estimation method.

Controller 14 among components making up position estimation device 101 according to the present disclosure may be implemented by software such as a program executed on a computer including a CPU (Central Processing Unit), a RAM (Random Access Memory), a ROM (Read Only Memory), a communication interface, an I/O port, a hard disk, a display and the like, or may be constructed by hardware such as an electronic circuit or the like.

As described above, the present exemplary embodiments have been described as exemplification of the technique according to the present disclosure. For this, the accompanying drawings and the detailed description have been provided.

Accordingly, the components described in the accompanying drawings and the detailed description may include not only essential components for solving the problem but also nonessential components for solving the problem, in order that examples of the above-described technique are discussed. The nonessential components should not be recognized to be essential simply because the nonessential components are described in the accompanying drawings and the detailed description.

Since the above-described exemplary embodiments are to exemplify the technique according to the present disclosure, various modifications, substitutions, additions, omissions or the like can be made in the scope of claims or the scope equivalent to the claims.

The present disclosure can be applied to a position estimation device that can estimate a precise position of a moving vehicle without an artificial marker or the like being disposed. Specifically, the present disclosure can be applied to a mobile robot, a vehicle, wall-surface inspection equipment or the like.

What is claimed is:

1. A position estimation device that estimates a position of a moving object on a road surface, comprising:
an illuminator that is provided in the moving object, and illuminates the road surface;
an imager that is provided in the moving object, has an optical axis non-parallel to an optical axis of the illuminator, and images the road surface illuminated by the illuminator; and
a controller that acquires road surface information including a position and a corresponding feature of a road surface to the position,
wherein the controller
determines a matching region from a road surface image captured by the imager
extracts a feature of the road surface from the road surface image in the matching region,
estimates the position of the moving object by performing matching processing between the extracted feature of the road surface and the road surface information,
determines validity of the matching region, and
performs the matching processing when determining the matching region is valid.

2. The position estimation device according to claim 1, wherein the illuminator illuminates the road surface, using parallel light.

3. The position estimation device according to claim 1, wherein the road surface information includes information indicating an absolute position as the position.

4. The position estimation device according to claim 1,
wherein the road surface information further includes information indicating a direction at the position, and
the controller estimates the position and an orientation of the moving object by the matching processing.

5. The position estimation device according to claim 1, wherein the illuminator illuminates the road surface, using pattern light, which is light forming a predetermined pattern.

6. The position estimation device according to claim 5, wherein the pattern light is striped pattern light or lattice pattern light.

7. The position estimation device according to claim 1,
wherein the corresponding feature of the road surface included in the road surface information includes a two-dimensional pattern of a gray scale or a concavo-convex shape of the road surface, and
the controller identifies, as the extracted feature of the road surface, a two-dimensional pattern of a gray scale or a concavo-convex shape of the road surface from a region illuminated by the illuminator in the road surface image, and performs the matching processing, based on the identified two-dimensional pattern.

8. The position estimation device according to claim 1,
wherein the corresponding feature of the road surface included in the road surface information includes a binarized image obtained by binarizing a road surface image with a gray-scale pattern or a concavo-convex shape of the road surface, and
the controller generates, as the extracted feature of the road surface, a binarized image obtained by binarizing the road surface image with a gray-scale pattern or a concavo-convex shape of the road surface, the matching processing including matching the generated binarized image and the road surface information.

9. The position estimation device according to claim 1,
wherein the controller further includes a position estimator that performs position estimation with a precision lower than that with which the controller estimates the position of the moving object, and
the controller narrows and acquires the road surface information, based on a result of the position estimation by the position estimator.

10. The position estimation device according to claim 1, wherein the controller performs the matching processing in accordance with a moving speed of the moving object.

11. The position estimation device according to claim 1, wherein the controller determines validity of the matching region, based on an illumination shape formed on the road surface by the illuminator.

12. The position estimation device according to claim 1, wherein the controller determines validity of the matching region, based on the extracted feature of the road surface.

13. A position estimation method for estimating a position of a moving object on a road surface, the position estimation method comprising:
illuminating the road surface, by use of an illuminator provided in the moving object;
imaging the road surface illuminated by the illuminator, by use of an imager that is provided in the moving object, and has an optical axis non-parallel to an optical axis of the illuminator;
acquiring road surface information including a position and a corresponding feature of a road surface to the position;
determining a matching region from a road surface image captured by the imager;
extracting a feature of the road surface from the road surface image in the matching region;
estimating the position of the moving object by performing matching processing between the extracted feature of the road surface and the road surface information;
determining validity of the matching region; and
performing the matching processing when determining the matching region is valid.
